(19) United States
(12) Patent Application Publication
(10) Pub. No.: US 2011/0083165 A1
(43) Pub. Date: Apr. 7, 2011

(54) Method and system for regulating, disrupting and preventing access to the wireless medium

(75) Inventors: K. N. Gopinath, Bangalore (IN); Pravin Bhagwat, Kendall Park, NJ (US)

(73) Assignee: AirTight Networks, Inc. (F/K/A Wibhu Technologies, Inc.), Mountain View, CA (US)

(21) Appl. No.: 12/749,528

(22) Filed: Mar. 30, 2010

Related U.S. Application Data
(63) Continuation of application No. 10/931,499, filed on Aug. 31, 2004, now abandoned.
(60) Provisional application No. 60/560,034, filed on Apr. 6, 2004.

(51) Int. Cl. G06F 15/16; H04W 84/02

(52) U.S. Cl. 726/4; 370/338

(57) ABSTRACT

A method for restricting one or more wireless devices from engaging in wireless communication within a selected local geographic region. The method includes receiving an indication comprising at least identity information. Preferably, the indication is associated with a selected wireless device, which is associated with an undesirable wireless communication within the selected local geographic region. The method includes selecting one or more processes directed to restrict the selected wireless device from engaging in wireless communication and performing a prioritized access to a wireless medium using at least one of one or more sniffer devices, which are spatially disposed within a vicinity of the selected local geographic region. The method transmits one or more packets from the at least one of one or more sniffer devices. Preferably, the one or more packets are directed to perform said one or more processes to restrict the selected wireless device.

### CROSS-REFERENCES TO RELATED APPLICATIONS

This present application is a continuation of U.S. patent application Ser. No. 10/931,499 filed Aug. 31, 2004, entitled “METHOD AND A SYSTEM FOR REGULATING, DISRUPTING AND PREVENTING ACCESS TO THE WIRELESS MEDIUM”, which claims priority to U.S. Provisional Application No. 60/560,034, titled “A Method and a System for Reliably Regulating, Disrupting and Preventing Access to Wireless Medium Through Distributed Passive and Active Wireless Sniffers,” filed Apr. 6, 2004, each of which is commonly assigned, and hereby incorporated by reference for all purposes.

### BACKGROUND OF THE INVENTION

The present invention relates generally to wireless computer networking techniques. More particularly, the invention provides a method and a system for providing intrusion prevention for local area wireless networks according to a specific embodiment. Merely by way of example, the invention has been applied to a computer networking environment based upon the IEEE 802.11 family of standards, commonly called “WiFi.” But it would be recognized that the invention has a much broader range of applicability. For example, the invention can be applied to Ultra Wide Band (“UWB”), IEEE 802.16 commonly known as “WiMAX”, Bluetooth, and others.

Computer systems proliferated from academic and specialized science applications to day to day business, commerce, information distribution and home applications. Such systems include personal computers, which are often called “PCs” for short, to large mainframe and server class computers. Powerful mainframe and server class computers run specialized applications for banks, small and large companies, e-commerce vendors and governments. Smaller personal computers can be found in many if not all offices, homes, and even local coffee shops. These computers interconnect with each other through computer communication networks based on packet switching technology such as the Internet protocol or IP. The computer systems located within a specific local geographic area such as office, home or other indoor and outdoor premises interconnect using a Local Area Network, commonly called, LAN. Ethernet is by far the most popular networking technology for LANs. The LANs interconnect with each other using a Wide Area Network called “WAN” such as the famous Internet. Although much progress occurred with computers and networking, we now face a variety of security threats on many computing environments from the hackers connected to the computer network. The application of wireless communication to computer networking further accentuates these threats.

As merely an example, the conventional LAN is usually deployed using an Ethernet based infrastructure comprising cables, hubs switches, and other elements. A number of connection ports (e.g., Ethernet ports) are used to couple various computer systems to the LAN. A user can connect to the LAN by physically attaching a computing device such as laptop, desktop or handheld computer to one of the connection ports using physical wires or cables. Other computer systems such as database computers, server computers, routers and Internet gateways also connect to the LAN to provide specific functionalities and services. Once physically connected to the LAN, the user often accesses a variety of services such as file transfer, remote login, email, WWW, database access, and voice over IP. Security of the LAN often occurs by controlling access to the physical space where the LAN connection ports reside.

Although conventional wired networks using Ethernet technology proliferated, wireless communication technologies are increasing in popularity. That is, wireless communication technologies wirelessly connect users to the computer communication networks. A typical application of these technologies provides wireless access to the local area network in the office, home, public hot-spots, and other geographical locations. As merely an example, the IEEE 802.11 family of standards, commonly called WiFi, is the common standard for such wireless application. Among WiFi, the 802.11b standard-based WiFi often operates at 2.4 GHz unlicensed radio frequency spectrum and offers wireless connectivity at speeds up to 11 Mbps. The 802.11g compliant WiFi offers even faster connectivity at about 54 Mbps and operates at 2.4 GHz unlicensed radio frequency spectrum. The 802.11a provides speeds up to 54 Mbps operating in the 5 GHz unlicensed radio frequency spectrum. The WiFi enables a quick and effective way of providing wireless extension to the existing LAN.

In order to provide wireless extension of the LAN using WiFi, one or more WiFi access points (APs) connect to the LAN connection ports either directly or through intermediate equipment such as WiFi switch. A user now wirelessly connects to the LAN using a device equipped with WiFi radio, commonly called wireless station, that communicates with the AP. The connection is free from cable and other physical encumbrances and allows the user to “Surf the Web” or check e-mail in an easy and efficient manner. Unfortunately, certain limitations still exist with WiFi. That is, the radio waves often cannot be contained in the physical space bounded by physical structures such as the walls of a building. Hence, wireless signals often spill outside the area of interest. Unauthorized users can wirelessly connect to the AP and hence gain access to the LAN from the spillage areas such as the street, parking lot, and neighbor's premises. Consequently, the conventional security measure of controlling access to the physical space where the LAN connection ports are located is now inadequate.

As merely an example, a threat of an unauthorized AP being connected to the LAN often remains with the LANs. The unauthorized AP creates security vulnerability. The unauthorized AP allows wireless intruders to connect to the LAN through itself. That is, the intruder accesses the LAN and any proprietary information on computers and servers on the LAN without the knowledge of the owner of the LAN. Soft APs and misconfigured APs connected to the LAN also pose similar threats. As another example, an unauthorized wireless station can inflict a denial of service (DOS) attack on WiFi network via various techniques such as injecting excessive traffic on the wireless link, transmitting at the slowest possible speed to occupy the wireless medium for longer time, sending excessive requests for reservation to wireless medium, sending spoofed deauthentication requests and the like. Some of these DOS attacks may also inadvertently occur form authorized wireless stations due to their misconfiguration.

Unauthorized ad hoc network is yet another example of potential security threat. The 802.11 standard also provides for formation of an ad hoc network among plurality of wireless stations, that is, the wireless stations in the ad hoc network communicate in a peer-to-peer fashion without reliance on an AP. An unauthorized wireless station can connect to the authorized wireless station using ad hoc networking feature. It can then inflict damage on the authorized station such as stealing data from it, transferring virus program to it, and the like. These and other limitations of conventional techniques are described in further detail throughout the present specification and more particularly below.

From the above, it is seen that improved techniques for wireless communication are highly desired.

### BRIEF SUMMARY OF THE INVENTION

According to the present invention, techniques directed to wireless computer networking are provided. More particularly, the invention provides a method and a system for providing intrusion prevention for local area wireless networks according to a specific embodiment. Merely by way of example, the invention has been applied to a computer networking environment based upon the IEEE 802.11 family of standards, commonly called “WiFi.” But it would be recognized that the invention has a much broader range of applicability. For example, the invention can be applied to Ultra Wide Band (“UWB”), IEEE 802.16 commonly known as “WiMAX”, Bluetooth, and others.

In a specific embodiment, the present invention provides a method for restricting one or more wireless devices from engaging in wireless communication within a selected local geographic region (e.g., office space, home, apartments, government buildings, warehouses, hot-spots, commercial facilities, etc.). The method includes receiving an indication comprising at least identity information. The indication is associated with a selected wireless device. The selected wireless device is associated with an undesirable wireless communication within the selected local geographic region. The method includes selecting one or more processes directed to restrict the selected wireless device from engaging in wireless communication. The method includes performing a prioritized access to a wireless medium using at least one of one or more sniffer devices. The one or more sniffer devices are spatially disposed in a vicinity of the selected local geographic region. The method includes transmitting one or more packets from the at least one of one or more sniffer devices. The one or more packets are directed to perform at least one of the one or more processes to restrict the selected wireless device.

In an alternative specific embodiment, the present invention provides a method for restricting one or more wireless devices from engaging in wireless communication within a selected local geographic region. The selected local geographic region comprises one or more sniffer devices. The method includes selecting one or more first processes associated with restricting the selected wireless device from engaging in wireless communication within the selected local geographic region. The method includes transmitting one or more packets from at least one of the one or more sniffer devices. The one or more packets are directed to perform at least one of the first processes to restrict the selected wireless device. The method includes monitoring a wireless activity associated with at least the selected wireless device. The monitoring is to determine if the selected wireless device has been restricted from engaging in the wireless communication after performing at least the first process. The method includes selecting one or more second processes associated with restricting the selected wireless device from engaging in wireless communication within the selected local geographic region. The method includes transmitting one or more packets from at least one of the one or more sniffer devices. The one or more packets are directed to perform at least one of the second processes to restrict the selected wireless device. The method also includes monitoring a wireless activity associated with at least the selected wireless device. The monitoring is to determine if the selected wireless device has been restricted from engaging in the wireless communication after performing at least the second process.

In yet an alternative specific embodiment, the invention provides a method for restricting one or more wireless devices from engaging in wireless communication within a selected local geographic region. The method includes receiving an indication comprising at least identity information. The indication is associated with a selected wireless device. The selected wireless device is associated with an undesirable wireless communication within the selected local geographic region. The method includes selecting one or more processes directed to restrict the selected wireless device from engaging in wireless communication. The one or more processes include at least a selective virtual jamming process or an access point flooding process or an acknowledgement collision process. The method includes transmitting one or more packets from at least one of one or more sniffer devices. The one or more sniffer devices are spatially disposed in a vicinity of the selected local geographic region. The one or more packets are directed to perform said one or more processes to restrict the selected wireless device.

In yet a further alternative specific embodiment, the present invention provides a method for restricting one or more wireless devices from engaging in wireless communication within a selected local geographic region using feedback and one or more additional processes to restrict wireless communication of the one or more wireless devices. The method includes selecting one or more first processes associated with restricting the selected wireless device from engaging in wireless communication within the selected local geographic region. The method includes transmitting one or more packets from at least one of one or more sniffer devices. The one or more sniffer devices are spatially disposed in a vicinity of the selected geographic region. The one or more packets are directed to perform at least one of the first processes to restrict the selected wireless device. The method includes monitoring a wireless activity associated with at least the selected wireless device. The method includes determining if the selected wireless device has been restricted from engaging in the wireless communication after performing at least the first process. The method includes selecting one or more second processes associated with restricting the selected wireless device from engaging in the wireless communication within the selected local geographic region. The one or more second processes is selected only if the selected wireless device has not been substantially restricted from engaging in the wireless communication within the selected local geographic region. The method includes transmitting one or more packets from at least one of the one or more sniffer devices. The one or more packets are directed to perform at least one of the second processes to restrict the selected wireless device. The method includes monitoring a wireless activity associated with at least the selected wireless device to determine if the selected wireless device has been restricted from engaging in the wireless communication after performing at least the second process.

In one specific embodiment, the present invention provides a system for restricting one or more wireless devices from engaging in wireless communication within a selected local geographic region. The system includes a main process module. The system includes an input handler coupled to the main process module. The input handler is adapted to receive an indication comprising at least identity information. The indication is associated with a selected wireless device. The selected wireless device is preferably associated with an undesirable wireless communication within the selected local geographic region. The system includes a selection module coupled to the main process module. The selection module is adapted to select one or more processes directed to restrict the selected wireless device from engaging in wireless communication. The system includes an access module coupled to the main process module. The access module is adapted to perform a prioritized access to a wireless medium using at least one of one or more sniffer devices. The one or more sniffer devices are spatially disposed within a vicinity of the selected local geographic region. The system includes an output handler coupled to the main process module. The output handler is adapted to transmit one or more packets from the at least one of one or more sniffer devices. The one or more packets are directed to perform at least one of the one or more processes to restrict the selected wireless device.

In an embodiment of the present invention the invention constructively utilizes that wireless communication protocol that does not support mutual authentication would be vulnerable to “Man-in-the-Middle” attacks. In an embodiment the wireless intrusion prevention is performed by launching man-in-the-middle attack between the wireless devices associated with undesirable wireless communication.

Certain security limitations of WiFi networks are overcome by a method and a system in accordance with embodiments of the present invention. The invention provides reliable and efficient solution to disable, disrupt, or regulate the wireless communication attempts by unauthorized devices. It provides fine-grained control over the extent of inflicted disruption. The invention can be used for intrusion prevention while achieving one or more desirable objectives such as for example minimizing the adverse impact of intrusion prevention on authorized devices, maximizing the impact on unauthorized devices, minimizing the computational overhead on the intrusion prevention system, minimizing the wastage of wireless bandwidth, selectively disabling the unauthorized devices, selectively allowing authorized devices, etc. The invention can further be used to prevent unauthorized devices from inflicting a DOS attack on the WiFi network. Depending upon the embodiment, one or more of these benefits may be achieved. These and other benefits will be described in more throughout the present specification and more particularly below.

Other features and advantages of the invention will become apparent through the following detailed description, the drawings, and the claims.

### BRIEF DESCRIPTION OF THE DRAWINGS

FIG. 1 shows a simplified LAN architecture that supports wireless intrusion prevention according to an embodiment of the present invention.

FIG. 1A illustrates a simplified flow diagram of an intrusion prevention method according to an embodiment of the present invention.

FIG. 1B illustrates a simplified flow diagram of an intrusion prevention method according to an alternative embodiment of the present invention.

FIG. 2 shows a simplified flow diagram of forced deauthentication/disassociation according to an embodiment of the present invention.

FIG. 3 shows a simplified flow diagram of virtual jamming according to an embodiment of the present invention.

FIG. 4 shows a simplified flow diagram of selective virtual jamming according to another embodiment of the present invention.

FIG. 5 shows a simplified flow diagram of AP flooding according to a yet another embodiment of the present invention.

FIG. 6 shows a simplified flow diagram of ACK collision according to an alternative embodiment of the present invention.

FIG. 7 shows a simplified flow diagram of link hogging according to a yet alternative embodiment of the present invention.

FIG. 8 shows a simplified flow diagram of adaptive method according to an embodiment of the present invention.

FIG. 9 shows a simplified flow diagram of adaptive method according to another embodiment of the present invention.

FIG. 10 shows a simplified flow diagram of adaptive method according to yet another embodiment of the present invention.

FIG. 11 shows a simplified system diagram of an intrusion prevention system according to an embodiment of the present invention.

FIG. 12 shows a simplified exemplary flowchart of desynchronizing a wireless network according to an embodiment of the present invention.

### DETAILED DESCRIPTION OF THE INVENTION

According to the present invention, techniques for wireless computer networking are provided. More particularly, the invention provides a method and a system for providing intrusion prevention for local area wireless networks. Merely by way of example, the invention has been applied to a computer networking environment based upon the IEEE 802.11 family of standards, commonly called “WiFi.” But it would be recognized that the invention has a much broader range of applicability. For example, the invention can be applied to UWB, WiMAX (802.16), Bluetooth, and others.

Before a full discussion of the various embodiments of the present invention, we have summarized additional limitations of conventional techniques, which we may have discovered. Here, conventional attempts have been made to provide mechanisms to thwart communication attempts by the unauthorized devices, with varying degrees of performance and reliability. In one conventional solution, when an unauthorized AP is detected, a query is launched to discover the Ethernet switch port to which said AP is connected and the corresponding port on the switch is deactivated. There are several limitations with this approach. For example, if the unauthorized AP functions as a Layer 2 bridge, the switch will not be able to locate the port at which said AP is connected. In addition, this approach requires that the Ethernet switches in the LAN have network management client capability. This and other limitations necessitate use of over-the-air (OTA) intrusion prevention techniques in which wireless communication involving unauthorized devices (e.g. unauthorized AP, unauthorized wireless station, etc.) is disrupted, disabled or regulated.

A conventional OTA prevention approach is to disrupt the wireless communication by transmitting a strong interference or noise signal on the radio channel where unauthorized wireless devices operate. Similar effect can also be achieved by injecting excessive data traffic on the radio channel so as to prevent normal communication from happening. However, these jamming approaches block the entire channel and thus block any authorized devices as well as neighbor networks which may be operating on the same channel. Hence these brute force approaches are not desirable.

An OTA prevention approach called “honeypot trap” that attracts intruding wireless station away from its current association with the unauthorized AP is also known in prior art. However, the effectiveness of this approach is dependent on the implementation details of wireless communication equipment. Worse, it may distract authorized users away while leaving intruding stations unaffected.

Conventional Wi-Fi networks are commonly susceptible to OTA DOS attacks. Some known DOS attacks are: Deauthentication or disassociation packet flood to break the association between AP and its client wireless stations, network allocation vector (NAV) based virtual jamming which involves creating flood of packets with a large value in the NAV field, flood of CTS (clear to send) packets to deny other nodes access to the wireless medium, and the like. The above DOS techniques can also be used for intrusion prevention, however do not provide reliable defense against intruders because of various reasons. For example, they may not be effective against wireless stations that use an aggressive authentication and association sequence and back-off. These DOS techniques may still allow intermittent communication of unauthorized devices. Also, the deauthentication and disassociation flood is not effective against ad hoc networks. Further, some of these brute force techniques jam the entire radio bandwidth and hence not preferable. Various methods and systems for overcoming certain limitations of conventional wireless can be found throughout the present specification and more particularly below.

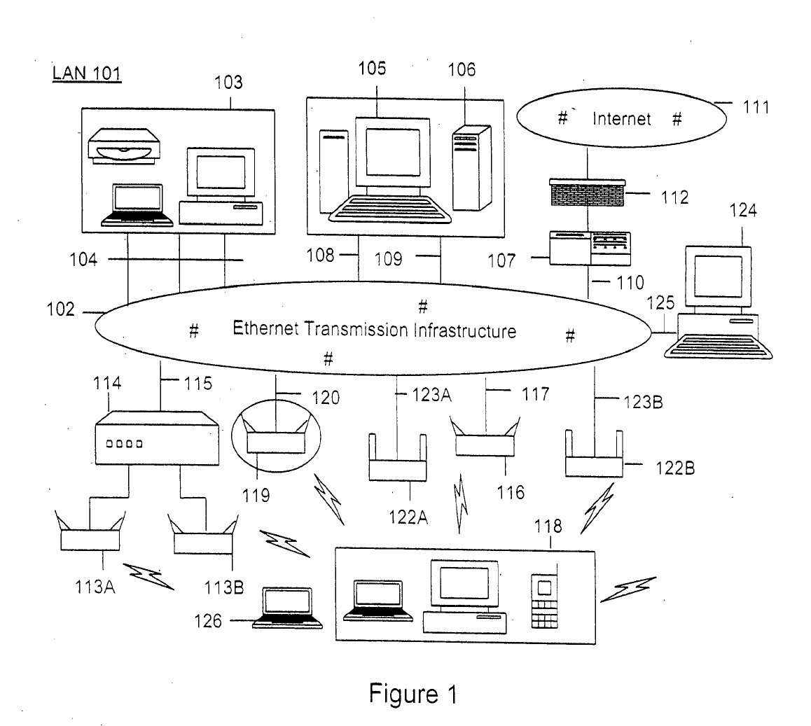

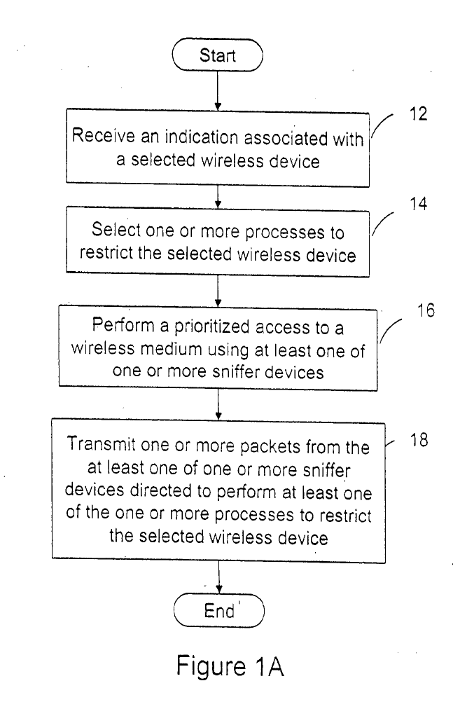

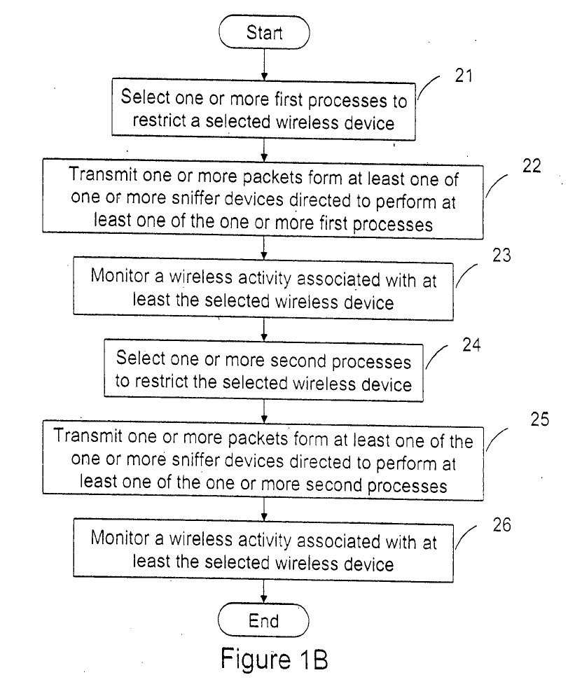

FIG. 1 shows the LAN architecture that supports the intrusion prevention according to one embodiment of the invention. This diagram is merely an example, which should not unduly limit the scope of the claims herein. One of ordinary skill in the art would recognize other variations, modifications, and alternatives. As shown in FIG. 1, the core transmission infrastructure 102 for the LAN 101 comprises of Ethernet cables, hubs and switches. Other devices may also be included. Plurality of connection ports (e.g., Ethernet ports) are provided for the various computer systems to be able to connect to the LAN. One or more end user devices 103 such as desktop computers, notebook computers, telemetry sniffers, etc., are connected to the LAN 101 via one or more connection ports 104 using wires (Ethernet cable) or other suitable devices. Other computer systems that provide specific functionalities and services are also connected to the LAN. For example, one or more database computers 105 may be connected to the LAN via one or more connection ports 108. Examples of information stored in database computers include customer accounts, inventory, employee accounts, financial information, etc. One or more server computers 106 may be connected to the LAN via one or more connection ports 109. Examples of services provided by server computers include database access, email storage, authentication, network management, and the like. The router 107 is connected to the LAN via connection port 110 and it acts as a gateway between the LAN 101 and the Internet 111. The firewall/VPN gateway 112 protects computers in the LAN against hacking attacks from the Internet 111. It may additionally also enable remote secure access to the LAN.

WiFi is used to provide wireless extension of the LAN. For this, one or more authorized WiFi APs 113A, 113B are connected to the LAN via WiFi switch 114. The WiFi switch is connected to the LAN connection port 115. The WiFi switch enables offloading from APs some of the complex procedures for authentication, encryption, QoS, mobility, etc., and also provides centralized management functionality for APs, making overall WiFi system scalable for large scale deployments. The WiFi switch may also provide additional functionalities such as firewall. One or more authorized WiFi AP 116 may also be directly connected to the LAN connection port 117. In this case AP 116 may itself perform necessary security procedures such as authentication, encryption, firewall, etc. One or more end user devices 118 such as desktop computers, laptop computers, PDAs equipped with WiFi radio can now wirelessly connect to the LAN via authorized APs 113A, 113B and 116. Although WiFi has been provided according to the present embodiment, there can also be other types of wireless network formats such as UWB, WiMax, Bluetooth, and others.

One or more unauthorized APs can be connected to the LAN. The figure shows unauthorized AP 119 connected to the LAN connection port 120. The unauthorized AP may not employ the right security policies. Also traffic through this AP may bypass security policy enforcing elements such as WiFi switch 114 or firewall/VPN gateway 112. The AP 119 thus poses a security threat as intruders such as wireless station 126 can connect to the LAN and launch variety of attacks through this AP. According to a specific embodiment, the unauthorized AP can be a rogue AP, a misconfigured AP, a soft AP, and the like. A rougue AP can be a commodity AP such as the one available openly in the market that is brought in by the person having physical access to the facility and connected to the LAN via the LAN connection port without the permission of the network administrator. A misconfigured AP can be the AP otherwise allowed by the network administrator, but whose security parameters are, usually inadvertently, incorrectly configured. Such an AP can thus allow wireless intruders to connect to it. Soft AP is usually a “WiFi” enabled computer system connected to the LAN connection port that also functions as an AP under the control of software. The software is either deliberately run on the computer system or inadvertently in the form of a virus program.

The intrusion prevention system according to the present invention is provided to protect the LAN 101 from wireless intruders. The system involves one or more sniffer devices 122A, 122B placed throughout a geographic region or a portion of geographic region including the connection points to the LAN 101. The sniffer is able to monitor the wireless activity in the selected geographic region. For example, the sniffer listens to one or more radio channels and captures packets being transmitted on the channel. Whenever transmission is detected, the relevant information about that transmission is collected and recorded. This information comprises of all or a subset of information that can be gathered from various fields in the captured packet such as 802.11 MAC (medium access control) header, 802.2 LLC (i.e., logical link control) header, IP header, transport protocol (e.g., TCP, UDP, HTTP, RTP, etc.) headers, packet size, packet payload and other fields. Receive signal strength (i.e., RSSI) may also be recorded. Other information such as the received signal strength, the day and the time of the day when said transmission was detected may also be recorded.

One or more sniffers 122A and 122B may also be provided with radio transmit interface. The transmit interface is used to transmit packets according to an embodiment of the method of present invention from the sniffer targeted to disabling or disrupting the wireless communication capabilities of intruding stations operating over the same wireless medium. In one specific embodiment, the sniffer is a dual slot device which has two wireless NICs. These NICs can be used in a variety of combinations, for example both for monitoring, both form transmitting, one for monitoring and the other for transmitting, etc., under the control of software. In another specific embodiment, the sniffer has only one wireless NIC. The same NIC is shared in a time division multiplexed fashion to carry out monitoring as well as defense against intrusion. Each sniffer 122A, 122B may also have Ethernet NIC using which it is connected to the connection port 123A, 123B of the LAN.

According to a specific embodiment, the sniffer device can be any suitable receiving/transmitting device. As merely an example, the sniffer often has a smaller form factor. The sniffer device has a processor, a flash memory (where the software code for sniffer functionality resides), a RAM, two 802.11a/b/g wireless network interface cards (NICs), one Ethernet port (with optional power over Ethernet or POE), a serial port, a power input port, a pair of dual-band (2.4 GHz and 5 GHz) antennas, and at least one status indicator light emitting diode (LED). The sniffer can be built using the hardware platform similar to one used to build wireless access point, although functionality and software will be different for a sniffer device. Of course, one of ordinary skill in the art would recognize other variations, modifications, and alternatives. Further details of the sniffers are provided throughout the present specification and more particularly below.

The sniffers can be spatially disposed at appropriate locations in the geographic area to be monitored for intrusion by using one or more of heuristics, strategy and calculated guess. Alternatively, a more systematic approach using an RF (radio frequency) planning tool is used to determine physical locations where said sniffers need to be deployed according to an alternative embodiment of the present invention.

One or more data collection servers 124 are connected to the LAN connection ports 125. Each sniffer conveys information about the detected wireless transmission to data collection server for analysis, storage, processing and rendering. The sniffer may filter and/or summarize the information before conveying it to the data collection server. The sniffer receives configuration information from the data collection server. In a preferred embodiment, the sniffer connects to the data collection server over the LAN through the wired connection port. In an alternate embodiment, the sniffer connects to the data collection server over the LAN through the wireless connection.

According to a specific embodiment of the present invention, upon the detection of intruding wireless station, one or more sniffers are chosen to execute OTA intrusion prevention. Said sniffer then uses one or more OTA prevention processes including, but not limited to, forced deauthentication/disassociation, virtual jamming, selective virtual jamming, AP flooding, acknowledgement (ACK) collision, beacon confusion, link hogging, and power save mode disruption, in order to disrupt wireless communication involving unauthorized devices.

Although infrastructure mode WiFi network has been provided according to the present embodiment, the invention also applies to ad hoc mode WiFi network in which one or more unauthorized stations are present. Further, the invention also applies to quench the unauthorized stations launching DOS attack on the WiFi network even in the absence of unauthorized APs.

According to an aspect of the invention, the OTA prevention process is combined with a “prioritized medium access”. This increases the reliability and the effectiveness of the technique. According to another aspect of the invention, the information derived from a “library” that stores implementation specific behaviour of WiFi equipment is used during the application of the OTA prevention process. This enables anticipating the impact of OTA prevention process on one or more specific wireless stations as well as using the appropriate parameter values during the application of the OTA prevention process.

FIG. 1A illustrates a simplified flow diagram of an intrusion prevention method according to an embodiment of the present invention. This diagram is merely an example, which should not unduly limit the scope of the claims herein. One of ordinary skill in the art would recognize other variations, modifications, and alternatives. As shown, the present invention provides a method for restricting one or more wireless devices from engaging in wireless communication within a selected local geographic region (e.g., office space, home, apartments, government buildings, warehouses, hot-spots, commercial facilities, etc.). The selected local geographic region may be occupied by one or more computer networks, e.g., wired, wireless. As shown, the method includes receiving an indication comprising identity information, step 12. The indication is preferably associated with a selected wireless device engaged in an undesirable wireless communication (e.g., an unauthorized AP or an unauthorized wireless station) within the selected local geographic region. For example, the identity information comprises a MAC address of the selected wireless device.

The method includes selecting one or more processes directed to restrict the selected wireless device from engaging in wireless communication as shown in step 14.

The method includes (step 16) performing a prioritized access to a wireless medium using at least one of one or more sniffer devices. The one or more sniffer devices are spatially disposed within or in a vicinity of the selected local geographic region.

As shown the method includes (step 18) transmitting one or more packets from the at least one of one or more sniffer devices. The packets are directed to perform at least one of the one or more processes to restrict the selected wireless device.

FIG. 1B illustrates a simplified flow diagram of an intrusion prevention method according to an embodiment of the present invention. This diagram is merely an example, which should not unduly limit the scope of the claims herein. One of ordinary skill in the art would recognize other variations, modifications, and alternatives. As shown, the present invention provides a method for restricting one or more wireless devices from engaging in wireless communication within a selected local geographic region (e.g., office space, home, apartments, government buildings, warehouses, hot-spots, commercial facilities, etc.). The selected local geographic region may be occupied by one or more computer networks, e.g., wired, wireless. As shown, the method includes (step 21) includes selecting one or more first processes associated with restricting the selected wireless device from engaging in wireless communication within the selected local geographic region.

As shown in step 22, the method includes transmitting one or more packets from at least one of the one or more sniffer devices. The one or more packets are directed to perform at least one of the first processes to restrict the selected wireless device.

The method includes, as shown in step 23, monitoring a wireless activity associated with at least the selected wireless device. The monitoring is to determine if the selected wireless device has been restricted from engaging in the wireless communication after performing at least the first process.

As shown in step 24, the method includes selecting one or more second processes associated with restricting the selected wireless device from engaging in wireless communication within the selected local geographic region. Preferably, the one or more second processes is selected only if the selected wireless device has not been substantially restricted from engaging in the wireless communication within the selected local geographic region.

The method includes (step 25) transmitting one or more packets from at least one of the one or more sniffer devices. The one or more packets are directed to perform at least one of the second processes to restrict the selected wireless device.

The method also includes, as shown in step 26, monitoring a wireless activity associated with at least the selected wireless device. The monitoring is to determine if the selected wireless device has been restricted from engaging in the wireless communication after performing at least the second process.

The above sequence of steps provides methods according to an embodiment of the present invention. As shown, the method uses a combination of steps including a way for restricting a wireless device from engaging in wireless communication within a selected local geographic region. Many other methods and system are also included. Of course, other alternatives can also be provided where steps are added, one or more steps are removed, or one or more steps are provided in a different sequence without departing from the scope of the claims herein. Additionally, the various methods can be implemented using a computer code or codes in software, firmware, hardware, or any combination of these. Depending upon the embodiment, there can be other variations, modifications, and alternatives.

In a specific embodiment, the prioritized medium access involves use of modified or non-standard timing values in the MAC protocol at the sniffer, so that the sniffer can gain prioritized access to the wireless medium. That is, transmission from the sniffer is ensured to occur before the transmission from other wireless stations in the WiFi network. The IEEE 802.11 MAC standard compliant devices follow a set of timing constraints for orderly use of the wireless medium. Examples of some of these timing constraints are distributed inter frame space (DIFS) which is the minimum interval of time that the wireless station needs to sense idle wireless medium before attempting new transmission, short inter frame space (SIFS) which is the time interval between the end of packet transmission and the start of transmission of its ACK, slot time which is the unit of time used by wireless stations, etc. For example, for direct sequence spread spectrum (DSSS) physical layer DIFS, SIFS and slot time are 50 microsecond, 10 microsecond and 20 microsecond respectively.

Other examples of timing constraints include the parameters of “backoff”. After sensing idle wireless medium for DIFS interval, each wireless station in the WiFi network needs to wait for a number of idle time slots (called backoff) before it can transmit a packet. The standard specifies the use of backoff that is uniformly distributed over the interval [0, CW−1] where CW is called contention window. The value CW at any wireless station lies between a minimum (CWmin) and a maximum (CWmax) inclusive. Further, when two or more stations transmit at approximately the same time thus resulting in collision, the value of CW at each of the stations causing collision is increased by a persistence factor (PF). The 802.11b specifies binary exponential backoff wherein, after each collision the contention window CW is doubled, i.e., PF=2. After a successful transmission CW is reset to CWmin.

In a specific embodiment, the sniffer grabs prioritized access to wireless medium using a number of ways, but not limited to, using small (deterministic) backoff such as backoff of 0 or 1 slot, using a smaller CWmin (for example CWmin=1, 3, etc.), using smaller value for slot time, using smaller SIFS, using smaller DIFS, using smaller PF (for example not increasing CW at all or increasing it by less than a factor of 2 after collision), and the like.

In another specific embodiment, a library that stores information about specific behavior of the WiFi equipment is built and maintained. The WiFi equipment (APs, radio cards for PCs, WiFi chipsets, etc.) from different vendors, even though standard compliant, often exhibits different implementation specific behavior. Such behavior is inferred by performing experiments on the equipment in a controlled environment such as laboratory environment. Alternatively, it can be inferred via observations made by the sniffers in an operational WiFi network.

As merely an example, the library can provide information about whether a specific OTA prevention technique is effective at all against specific WiFi equipment. This is important because certain implementations may have mechanisms to specifically foil certain OTA prevention techniques in the interest of preventing DOS attacks. The library may further provide information about values of one or more parameters to be used during application of specific OTA prevention technique for it to be most effective against the specific WiFi equipment. The following table shows merely an example of the library.

For AP flooding:

Cisco AP 350 series: Required associations=128, Detects MAC spoofing

Proxim AP 600 series: Required association=256, Does not detect MAC soofing

For forced deauthentication:

Cisco Aironet client card: Transmit 1 deauthentication packet every 50 ms

Linksys client card: Transmit 1 deauthentication packet every 800 ms

Card with MAC address 00:0B:00:00:3B:EF: Transmit 1 deauthentication packet every 35 ms

For virtual jamming:

Cisco AP 350 series: Use beacon packet with large NAV value

Proxim AP 600 series: Use RTS packet with large NAV value

Client card with MAC address 00:45:00:00:3B:EF: Use CTS packet

Linksys client card: Not effective

For ACK collision:

Linksys client card: Use a different preamble

Cisco client card: Use a smaller SIFS and low transmission rate

Proxim AP 600 series: Use low transmission rate and transmission on adjacent channel

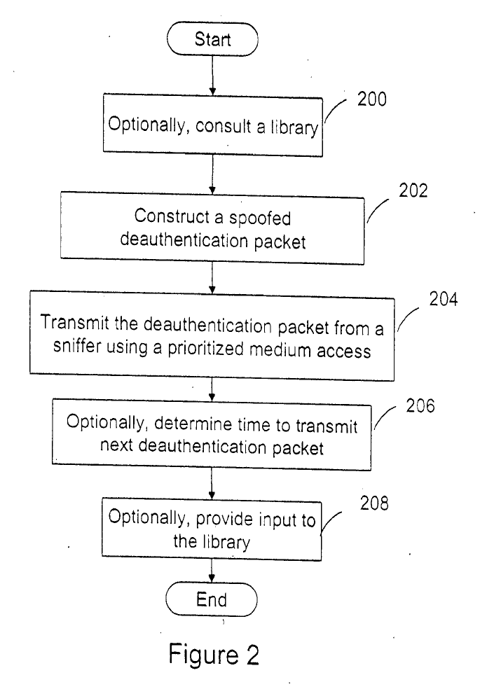

A preferred embodiment of the forced deauthentication/disassociation for OTA intrusion prevention according to present invention is now described. Said technique involves the transmission of one or more spoofed deauthentication and/or disassociation packets from the sniffer. Said packet has the effect of breaking the connection between the AP and one or more of its associated wireless stations. An example embodiment of this method to disrupt wireless stations in a basic service set (BSS) is now described with reference to FIG. 2. This diagram is merely an example, which should not unduly limit the scope of the claims herein. One of ordinary skill in the art would recognize other variations, modifications, and alternatives.

Step 200 corresponds to the optional step of querying the library for obtaining information specific to one or more stations in the BSS. For example, the vendor of specific WiFi device (AP, PC client card, etc.) can always be identified from the first 3 bytes of the MAC address of the device. Once the vendor is identified, the library can provide information about the applicability or effectiveness of forced deauthentication/disassociation technique and/or parameters to be used for its effective application towards said device. Alternatively, the library can furnish said information based on the observation input received from the sniffer regarding specific wireless station during earlier application of said technique. As merely an example, the library indicates the frequency with which the spoofed deauthentication and/or dissociation packets need to be transmitted to keep said station disabled.

In step 202, a spoofed 802.11 deauthentication packet is constructed. In a specific embodiment, the packet has source address as the MAC address of the AP and destination address as the broadcast address so as to disconnect all stations from the AP. The reason code in the packet can be, for example, “unspecified reason”. In alternate embodiment, the deauthentication packet has source address as the MAC address of the AP in the BSS and destination address as the address of specific wireless station so as to disconnect that specific station from the AP. The reason code in the packet can be, for example, “unspecified reason”. In yet an alternate embodiment, the spoofed deauthentication packet has the source address as the MAC address of one of the wireless stations and the destination address as the MAC address of the AP. The reason code in the packet can be, for example, “unspecified reason” or “sending station is leaving BSS”. This embodiment is particularly useful to break the connection between the AP and that wireless station which is hidden from the sniffer that is, the radio signal from the sniffer cannot reach said wireless station due to intervening obstacles.

The step 204 corresponds to transmitting the deauthentication packet from the sniffer via prioritized medium access. In an embodiment where the deauthentication packet is transmitted in response to an observed authentication request from the specific station, the packet is transmitted before the AP transmits its authentication (success) response.

An optional step 206 is performed to determine the time to transmit next deauthentication packet. This may be based on the information derived from the library and/or on the observation made by the sniffer of a new undesirable active connection between the AP and a wireless station. For the latter, the sniffer performs passive monitoring of wireless transmissions in the BSS and/or performs active probing. In active probing, a spoofed packet (for example class 2 packet) with the source address as the MAC address of the disconnected wireless station is transmitted by the sniffer to the AP. The sniffer further verifies that a deauthentication packet is received from the AP with desired reason code (for example “class 2 frame received from nonauthenticated station”).

In one embodiment, the monitoring process to observe the effect of over the air prevention process is performed by the same sniffer that performs the prevention process. In an alternative embodiment, the monitoring process to observe the effect of over the air prevention process is performed by one or more different sniffers than the one that performs the prevention process. The combination can also be used.

In an optional step 208, input is provided to the library based on the observations performed by the sniffer in the previous step. For example, the duration of time for which the station remains disconnected after being forcefully disconnected in step 204 can be provided as an input to the library. Such inputs enable updating of the library.

In an alternative embodiment, the forced deauthentication/dissociation is performed by transmitting a spoofed association request from the sniffer with the station's MAC address as source address and proposing arbitrary parameters in the various fields of the association request. This has the effect of the AP rejecting the proposed parameters and disconnecting the station. As before, preferably the spoofed association request is transmitted using the prioritized medium access.

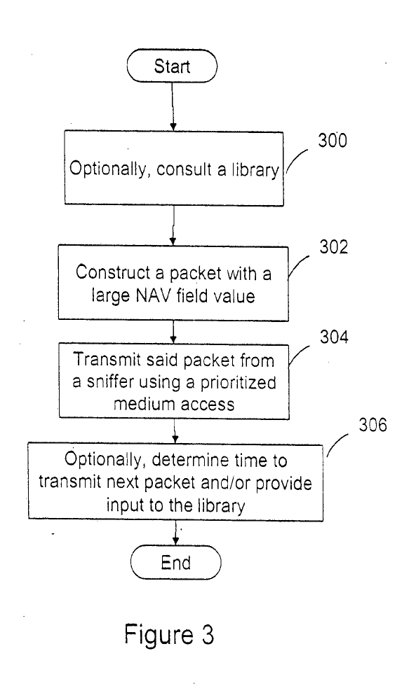

A preferred embodiment of the virtual jamming for OTA intrusion prevention according to present invention is now described. The virtual jamming involves transmitting artificially large values in the NAV field of transmitted packets so as to prevent other wireless stations from transmitting at least for the duration of time equal to NAV value. The IEEE 802.11 standard specifies two types of carrier sense mechanisms: physical carrier sensing and virtual carrier sensing. In the former, the wireless station listens to the radio channel to detect if a transmission is occurring and if so, waits for the ongoing transmission to complete before attempting new transmission. The second mechanism is based on the “duration” or NAV field in the transmitted packets. This field can be used by a first station (transmitter) to reserve the wireless medium for a specified amount of time (not exceeding 32767 microsecond) for communication with a second station (receiver). Any other station that listens to the transmission from the first station and decodes the packet, refrains from transmitting for the amount of time provided in the NAV field. An example embodiment of this method to disrupt stations in a BSS or an ad hoc network is described with reference to FIG. 3. This diagram is merely an example, which should not unduly limit the scope of the claims herein. One of ordinary skill in the art would recognize other variations, modifications, and alternatives.

As before, the step 300 corresponds to the optional step of querying the library for obtaining information specific to one or more stations. For example, the library can indicate if the specific station honors NAV field in all the packets or specific type of packets such as CTS (clear to send) packets.

In step 302, a packet with a high NAV field value (for example 25000) is constructed.

In step 304, the sniffer transmits said packet over the wireless medium. Preferably prioritized medium access is used to transmit the packet. This packet can be addressed to the broadcast address, to any wireless station in said BSS/ad hoc network or to a fake address. In addition, the source address in this packet may be spoofed to the source address of the AP in the BSS or any station in the ad hoc network.

In optional step 306, time to transmit next packet for virtual jamming is determined In one specific embodiment, next packet is transmitted after the timeout value equal to the NAV value in the previous packet. In another specific embodiment, the determination is based on the observation made by the sniffer of a new undesirable transmission in the BSS or the ad hoc network. Optionally, input is provided to the library based on the observation performed by the sniffer. For example, if the sniffer observes that a particular station does not honor the NAV field in the packet (that is transmission from the station occurs before the virtual jamming period indicated by the NAV value in the previous packet expires), this information is communicated to the library.

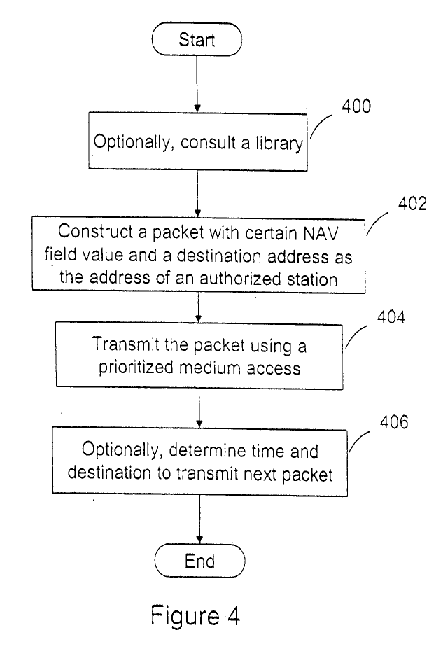

A preferred embodiment of the selective virtual jamming for OTA intrusion prevention according to present invention is now described. The selective virtual jamming is used to selectively block transmissions of one or more specific wireless stations, as opposed to blocking all the stations in a BSS or an ad hoc network. This is particularly useful if a given BSS or an ad hoc network comprises both authorized and unauthorized stations. This technique exploits the fact that according to the IEEE 802.11 standard a station that is the destination of a packet need not honor the value in the NAV field. An example embodiment of this method to selectively disrupt stations in a BSS or an ad hoc network is now described with reference to FIG. 4. This diagram is merely an example, which should not unduly limit the scope of the claims herein. One of ordinary skill in the art would recognize other variations, modifications, and alternatives.

Step 400 corresponds to the optional step of querying the library for obtaining information specific to one or more stations. For example, the library can indicate if the specific station honors NAV field in all the packets or specific type of packets such as CTS (clear to send) packets.

In step 402 a packet with a destination address of an authorized station and a certain NAV field value (for example 500) is constructed.

In step 404 said packet is transmitted by the sniffer. Optionally, prioritized medium access is used to transmit said packet. All the stations that receive this packet except the destination station will defer access to the wireless medium for at least the time period equal to the NAV value. During this interval, said destination station gets opportunity to transmit.

In step 406, the appropriate time to transmit the next packet from the sniffer and the destination address for the packet are determined. For example, transmission opportunities can be provided to authorized stations in a round robin fashion or according to some other scheduling policy such as variants round robin (weighted, hierarchical, multiclass, deficit, etc.), weighted fair queuing, and the like.

A preferred embodiment of AP flooding for OTA intrusion prevention according to present invention is now described. The AP flooding works by overwhelming the AP's computational resources. Commonly found practical implementations of AP maintain certain state about the wireless stations associated with the AP. This state will typically be maintained in a fixed size data structure and thus the number of stations an AP can service is limited, as merely an example, 128 in case of Intersil Prism chipset based HostAP or 256 in case of Cisco 350 series AP. Once the limit on the number of stations an AP can service is reached, new stations cannot be accommodated by the AP for a long duration of time usually in the range of minutes, as merely an example, 5 minutes in case of Intersil HostAP or 30 minutes on a Cisco 350 series AP.

The AP flooding can provide a highly scalable method for disrupting unauthorized APs and their associated wireless stations. The high scalability is achieved as the time for which the unauthorized devices can be disabled by an instance of application of this technique is large (e.g., of the order of minutes compared to the order of milliseconds for other techniques such as virtual jamming)

The AP flooding can be applied directly to disrupt an AP that supports open system authentication. On the other hand, for an AP using shared key authentication the method is complemented by a utility (such as those publicly available on the Internet) that recovers the WEP encryption and authentication keys by observing traffic between the AP and the associated wireless station. The recovered WEP key is then used by the sniffer for authentication step during the association procedure in AP flooding.

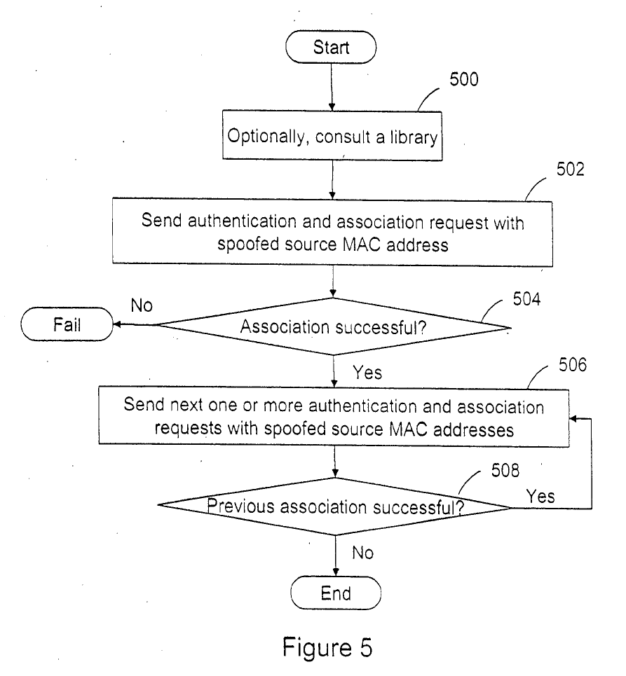

An example embodiment of AP flooding method to disrupt an AP and hence all the stations in a BSS is described below with reference to FIG. 5. This diagram is merely an example, which should not unduly limit the scope of the claims herein. One of ordinary skill in the art would recognize other variations, modifications, and alternatives.

As before, the step 500 corresponds to the optional step of querying the library for obtaining information specific to the AP to be disrupted. For example, the library can indicate the maximum number of associations required. Further, it can also provide information about the time duration for which said AP will be disabled after successful application of this technique. The latter helps in the repeated application of AP flooding technique at appropriate intervals of time.

In step 502, the sniffer transmits authentication and association request with arbitrary source address (for example hexadecimal 00:0F:00:00:00:00) and said AP's MAC address as the destination address. Optionally, prioritized medium access can be used to transmit the authentication and association request packets. In a specific embodiment, the association request packet is transmitted after receiving successful response to authentication request packet (e.g., authentication response packet) from the AP.

Step 504 verifies if the association is successful, for example by observing the association response packet from the AP.

On detection of successful association in the preceding step, in step 506 a sequence of authentication and association requests are sent to the AP, preferably each request with different source address. Optionally, prioritized medium access can be used to transmit the authentication and association request packets.

In one specific embodiment the next authentication and association request in the sequence is transmitted after receiving successful response to one of the previous association request packets (e.g., via association response packet) from the AP. This is shown as step 508 in FIG. 5. This continues until the association failure response is received, for example, association response packet is received with status code “association denied because AP is unable to handle additional associated stations” or a threshold number of requests have been sent whichever happens first.

In an alternative specific embodiment, the next authentication and association request is transmitted without waiting for any of the previous association requests to succeed (not shown in FIG. 5). This continues until the association failure response is received, for example, association response packet with status code “association denied because AP is unable to handle additional associated stations” or a threshold number of requests have been sent whichever happens first.

In a specific embodiment, the preceding steps are repeated at regular intervals to disrupt the BSS for desired duration. For this, an optional step (not shown in FIG. 5) of determining the next time to apply AP flooding is performed. In a specific embodiment, this determination is based on the information derived from the library and/or observations made by the sniffer. For example, the absence of periodic beacon packet transmission from said AP can be used to verify that said AP is non-usable. Alternatively, the absence of any new successful association establishments with the AP by the wireless stations is used to infer that the AP is non-usable. Yet alternatively, the sniffer actively probes the AP by sending a packet that elicits a response. Based on the response or the lack of it, the sniffer infers that the AP is non-usable. In a specific preferred embodiment, the sniffer sends association request to the AP and expects to receive association response with status code “association denied because AP is unable to handle additional associated stations” to infer that the AP is non-usable. Optionally, the duration of time for which the AP remains non-usable after application of AP flooding is communicated to the library.

Note that some APs attempt to detect spoofed source MAC addresses by ensuring if the ACK is transmitted in response to the packets (for example, authentication or association response packets) transmitted by the AP to the source MAC address from which authentication or association request was received. To account for this, as an additional step the sniffer would send acknowledgement to the AP when it detects the transmission of packet from the AP to the MAC address that the sniffer has recently used in the spoofed packet.

Other alternative embodiments of AP flooding exploit some of the other implementation vulnerabilities to bring down an AP. As merely an example, sending certain specially crafted packets such as invalid fragments (MAC or IP level), garbled packets (with improper CRC bits) and the like to the AP, can bring down the AP by overwhelming the AP's fragment reassembly queues or crashing or rebooting of the AP. In a specific preferred embodiment, the fragments are sent with spoofed MAC addresses of a plurality of stations. In an alternative embodiment, the fragments are sent with the spoofed MAC address of one station.

A preferred embodiment of ACK collision for OTA intrusion prevention according to present invention is now described. The ACK collision involves creating a colliding acknowledgement (ACK) packet subsequent to transmission of a packet to or from a station to be disrupted. The 802.11 standard mandates the generation of an ACK packet when a station successfully receives a packet that is destined to it. In ACK collision method, the sniffer transmits a spoofed colliding ACK when it detects the transmission of packet to or from the station to be disrupted. Continuously inflicting ACK collision results in the transmitter of the original packet not receiving an error free or decodable ACK and eventually halting further transmission. By inflicting ACK collision after the packet transmission to or from the AP in a BSS, the entire BSS can be disrupted. Alternatively, by inflicting ACK collision after the packet transmission to or from a specific station, the specific station can be disrupted. The ACK collision can be inflicted by a number of ways including, but not limited to, transmitting misformed ACK packet or ACK packet with random bits, introducing CRC errors in ACK packet, transmitting spoofed ACK always at lowest rate such as 1 Mbps, spoofing the ACK on an adjacent radio channel, increasing the transmit power for spoofed ACK, spoofing ACK with different preamble (short/long), spoofing ACK with a plurality of sniffers, dynamically changing modulation scheme, and the like.

In the custom 802.11 radio device, the ACK is generated directly by the hardware. Hence, it may not possible to programmatically generate the colliding ACK at the required time instant, say, using the driver software. In a specific embodiment, the method of invention performs a automatic ACK generation at the required instant of time by changing the MAC address of the wireless NIC in the sniffer to that of the AP or the wireless station whose ACK transmissions are to be disrupted.

If a sniffer device is constructed using standard 802.11 radio equipment (e.g., chipset, NIC), the number of options available to inflict ACK collision may be limited. For example, it may not be possible to create a random or misformed ACK because the ACK packet may be constructed in the hardware itself upon successful reception of the preceding packet. In one embodiment of the sniffer, the sniffer is equipped with a device that is capable of introducing anomalies in the packets/radio signals that are transmitted or ready to be transmitted over the wireless medium. For example, said device can receive the radio signal, amplify it, distort it and retransmit it. The device can be activated when ACK collision is to be inflicted.

Optionally, the ACK collision is combined with prioritized medium access by sending colliding ACK from the sniffer prior to SIFS after the end of transmission of previous packet. This has the effect of forcing the receiver at the unauthorized station to lock onto the signal from the sniffer and thus reliably receive the colliding ACK thereby corrupting the real ACK. This is very effective for stations that implement DSSS transmission technique.

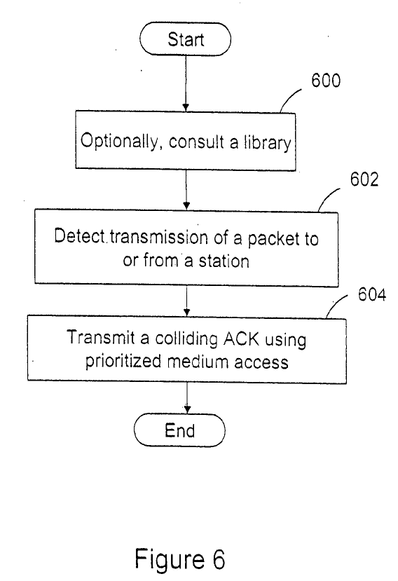

An example embodiment of the ACK collision method to disrupt a wireless station is described below with reference to FIG. 6. This diagram is merely an example, which should not unduly limit the scope of the claims herein. One of ordinary skill in the art would recognize other variations, modifications, and alternatives.

As before, the step 600 corresponds to the optional step of querying the library for obtaining information specific to the wireless station to be disrupted. For example, the library can indicate the most appropriate method to create colliding ACK for said station based on its vendor information.

In step 602, the sniffer monitors the radio channel to detect transmission of a packet to or from said station.

In response to this transmission, in step 604 the sniffer transmits a colliding ACK. The colliding ACK is optionally transmitted using prioritized medium access by transmitting it before the standard SIFS time.

A preferred embodiment of beacon confusion for OTA intrusion prevention according to present invention is now described. The beacon confusion method involves transmission of one or more beacon packets from the sniffer so as to confuse the wireless stations in a BSS. Beacon packets are normally used by APs in the 802.11 networks to announce their existence so that wireless stations can associate and remain synchronized with them. By transmitting fake beacon packets from the sniffer with the AP's address as the source address, it is possible to disrupt wireless stations associated with said AP. Preferably, these fake beacon packets are transmitted using prioritized medium access. Various parameters in the fake beacon packets such as timestamp, beacon interval, capability information, SSID, supported rates, physical layer parameters (such as DSSS, FH, etc.), contention free (CF) parameters, QoS parameters, radio resource management parameters and the like, can be set to arbitrary values to confuse the wireless stations. In one specific embodiment, the spoofed beacons can be transmitted every “beacon interval” of the BSS.

In some embodiments, beacon confusion for OTA intrusion prevention can destabilize/desynchronize a BSS. This can work by crafting artificial beacons that try to confuse the clients associated with a rogue AP. Techniques for causing disruption in AP cell include (but are not limited to) sending: (i) Beacon Frames to destabilize client device(s) (e.g., beacon with a different channel, beacon with a different SSID), (ii) Beacon Frames to destabilize client(s), (as above) at a frequency much higher than beacons sent by an actual AP, (iii) Beacon Frames with a wrong Beacon interval and like.

In alternative embodiments, beacon confusion for OTA intrusion prevention works by crafting certain packets that confuse the rogue AP and clients as far as the power-save behaviour is concerned. That is, an AP is wrongly informed that the client is entering power-save mode, so that it stops transmitting packets to the client. It is possible to exploit power save features of the MAC protocol to prevent a client from communicating. The techniques include (but are not limited to) sending: (i) Frames that indicate Power Save mode change of a client (Client Going to sleep), (ii) Beacon Frames with TIM bits set at wrong intervals (to confuse client(s) into awakening at wrong time instances), (iii) Beacon Frames with DTIM bits set at wrong intervals (to confuse client(s) into awakening at wrong time instances).

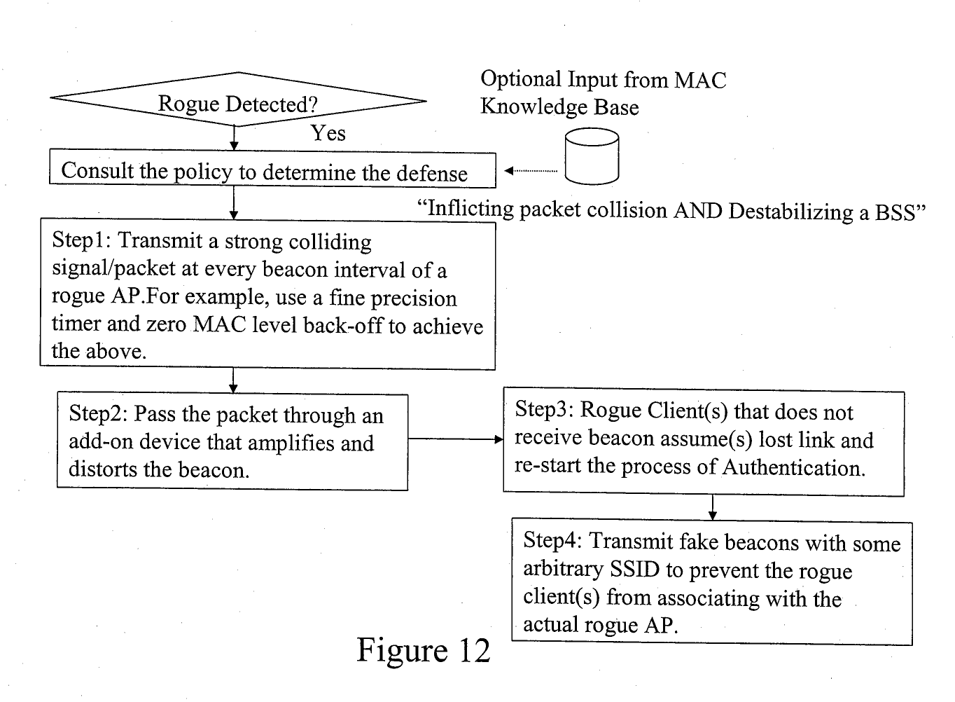

In yet an alternative embodiment, a combination of the techniques can be used as illustrated by simplified flowchart in FIG. 12. This diagram is merely an example, which should not unduly limit the scope of the claims herein. One of ordinary skill in the art would recognize other variations, modifications, and alternatives. This specific embodiment based on “Inflicting Packet Collision” and “Destabilizing/Desynchronizing a BSS” to specifically stall the communication of a device and/or destabilize a BSS works as follows. The basic idea behind the technique is that a client that does not receive beacon from its associated AP will assume a lost link and try to associate again (possibly, to a different AP). The steps in this specific embodiment of the invention are explained below.

Step 1: Mimic the beacon generation behavior of the rogue AP. Use a counter (e.g. equal to the beacon interval of the AP) to determine approximately when the rogue AP generates a beacon. Generate a colliding signal to corrupt the beacon. The potency of the technique can be further increased by not having the card to back-off before a transmission.

Step 2: As an option, pass the beacon through an add-on device that amplifies and distorts the spoofed beacon, to increase the probability of corruption.

Step 3: A client continually loosing beacons assumes a lost link and tries to associate with a possibly new AP.

Step 4: Generate spoofed beacons with invalid BSSID so that the client is prevented from associating with the actual rogue AP. As can be noted, the effect of the above steps would be to disconnect the client's existing undesirable connection. As can also be noted that the client can get connected to transmitter of the spoofed beacons.

A preferred embodiment of link hogging for OTA intrusion prevention according to present invention is now described. The link hogging involves continually transmitting packets from the sniffer to hog the link and thus inhibit transmissions of any other stations on the link. Preferably, prioritized medium access is used to transmit these packets from the sniffer.

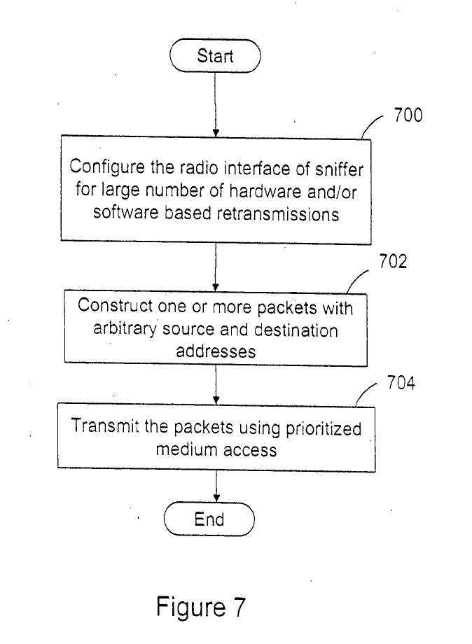

An example embodiment of this method to disrupt wireless stations in a BSS or an ad hoc network is described with reference in FIG. 7. This diagram is merely an example, which should not unduly limit the scope of the claims herein. One of ordinary skill in the art would recognize other variations, modifications, and alternatives.

In optional step 700, the sniffer's radio interface is configured to perform large number of hardware and/or software retransmissions if the ACK is not received for the preceding packet transmission.

In step 702, one or more packets with arbitrary source and destination addresses are constructed. Optionally, high value of NAV field (e.g., 32765) is used in these packets. If the benefit of optional step 700 is desired, the destination address should be such that it is not a broadcast and does not elicit an 802.11 ACK packet. For example, the destination address can be the address of the station not present in the BSS or the ad hoc network.

In step 704, said packets are transmitted by the sniffer on the wireless medium. Preferably, prioritized medium access is used by the sniffer to transmit these packets on the wireless medium.

If the optional step 700 is performed, each of the transmissions in step 704 would result in lack of ACK. Detecting this, the radio interface would retransmit the packet. This enables generating packet flood at a rate higher than the rate at which packets are offered to the radio interface by higher layers in the protocol stack.

A preferred embodiment of the power save mode disruption for OTA intrusion prevention according to present invention is now described. The 802.11 standard has provisions for a wireless station to go in a power save mode to reduce battery consumption. The station can send special packets to the AP to indicate that it is entering the power save mode. Subsequently, the AP buffers the packets that are destined to the station, and then send indication about the buffered data to the station (e.g., using special fields in the beacon packet). The station then sends request to the AP (e.g., PS Poll packet) and receives the buffered data. By transmitting certain spoofed packets from the sniffer, it is possible to cause packet delivery at wrong instants of time (e.g., AP transmitting data when the station is in power-save mode), so that the station does not receive the data. As an example, this is achieved by a number of way including, but not limited to, transmitting one or more spoofed PS Poll packets from the sniffer to the AP with the station's MAC address as source address in the packets, transmitting one or more a spoofed packets indicating that the station is in “Constant Awake Mode” from the sniffer to the AP with the station's MAC address as source address in the packets, etc. Preferably the spoofed packets are transmitted using the prioritized medium access.

Generating spoofed beacon packets from the sniffer with TIM bits set at arbitrary intervals, generating spoofed beacon packets from the sniffer with DTIM bits set at arbitrary intervals are some of the other ways to inflict power save mode disruption. Said beacon frames are preferably transmitted using the prioritized medium access.

Alternatively, the power save mode disruption technique can be used to limit the bandwidth usage of a station that is impacting the performance of the network (e.g., stations operating at a very small link-speed and hence holding up the wireless medium for long period of time). This can be achieved in a number of ways including, but not limited to, transmitting spoofed packet from the sniffer to the AP with the source address of a station to be regulated indicating that the station is entering the power saving or sleep mode. Preferably, the packet is transmitted using prioritized medium access. This results in the AP buffering the data destined to the station rather than immediately transmitting it. This regulates the bandwidth usage of the station.

According to an aspect of the present invention, the various OTA prevention methods are applied in an adaptive manner to arrive at an optimal OTA prevention method or an optimal combination of OTA prevention methods for a given intrusion event. For a specific intrusion prevention method, its effectiveness is determined from the information derived from the library and/or by applying said method and observing its effect on the concerned wireless stations. If said method is deemed ineffective, inefficient or unreliable, a new OTA prevention method or the same method with different parameters is applied instead of or in addition to the current OTA method.

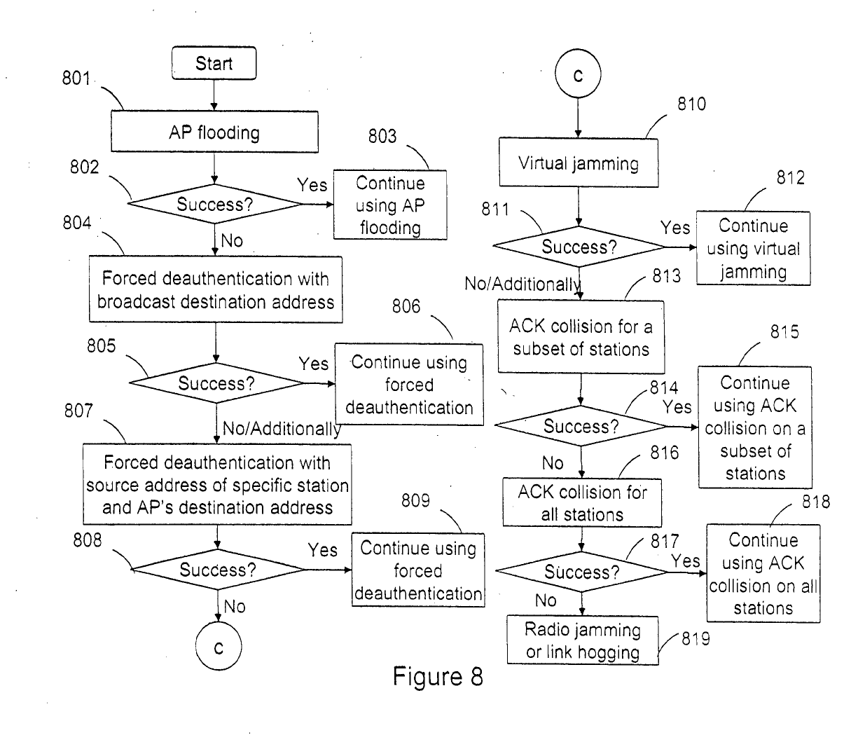

An example embodiment of the adaptive method to disrupt a BSS (for example formed by unauthorized AP and comprising one or more associated wireless stations) according to present invention in described below with reference to FIG. 8. This diagram is merely an example, which should not unduly limit the scope of the claims herein. One of ordinary skill in the art would recognize other variations, modifications, and alternatives. The adaptive method is applied to achieve prolonged disruption to BSS with limited overhead on the sniffers.

Accordingly in step 801, the library is consulted to identify if AP flooding is effective against said AP equipment. If it is known to be effective, AP flooding according to the present invention is applied to disrupt the BSS.

In step 802, the sniffer continues to monitor if the AP is rendered non-usable. For example, the absence of periodic beacon packet transmission from said AP can be used to infer that said AP is non-usable. Alternatively, the absence of any new successful association establishments with the AP by the wireless stations is used to infer that the AP is non-usable. Yet alternatively, the sniffer actively probes the AP by sending a packet that elicits a response. Based on the response or the lack of it, the sniffer infers that the AP is non-usable. In a specific preferred embodiment, the sniffer sends association request to the AP and expects to receive association response with status code “association denied because AP is unable to handle additional associated stations” to infer that the AP is non-usable. Based on these observations, decision is taken as to whether AP flooding yields results to meet the desired objective. That is, whether it indeed makes the AP non-usable and whether the AP remains non-usable for the desired duration of time.

If deemed to be effective, the intrusion prevention system continues to apply AP flooding as shown in step 803. On the other hand, if AP flooding does not perform as desired, the intrusion prevention system experiments with the new method.

Thus in step 804, forced deauthentication/disassociation is used according to the present invention with broadcast address as destination address in the deauthentication packets.

In step 805, the effect of forced deauthentication/disassociation on the unauthorized BSS is observed. For this the sniffer continues to monitor the transmissions in the BSS. If no transmissions from a specific station are detected, said station is inferred to be disconnected from the AP.

If at least a large subset of stations is inferred to be disconnected from the AP for the desired duration of time, forced deauthentication/disassociation with broadcast address is continued as shown in step 806.

For the remaining subset of stations, in step 807 forced deauthentication/disassociation according to present invention is applied with source address as the address of each of the remaining subset of stations and destination address as the address of the AP in deauthentication packets. This is useful to disrupt the station in the BSS that is hidden from the sniffer (for example due to obstacles to radio propagation from the sniffer to the station) and hence could not be disconnected from the AP by broadcast deauthentication packets transmitted from the sniffer.

In step 808, the sniffer continues to monitor the transmissions in the BSS. The sniffer looks for any communication between the AP and said remaining subset of stations. Alternatively, the sniffer uses active probing in which a spoofed packet (for example class 2 packet) with the source address as the MAC address of the disconnected wireless station is transmitted by the sniffer to the AP. The sniffer further verifies that a deauthentication packet is received from the AP with desired reason code (for example “class 2 frame received from nonauthenticated station”).

If the sniffer infers that said remaining subset of wireless stations have been disconnected from the AP, the forced deauthentication/disassociation with said stations' addresses as source addresses is continued as shown in step 809.

On the other hand, suppose the forced deauthentication/disassociation does not perform as desired, for example due to large number of hidden stations, due to the stations using aggressive authentication and association subsequent to their forced deauthentication, and the like. Then in step 810 virtual jamming according to the present invention is applied.

In step 811, the effect of virtual jamming is monitored by the sniffers. For example, lack of detection by the sniffer of any packet transmission to or from said AP can be used to verify that no stations are communicating any more with said AP.

If at least a large subset of stations is inferred to be disabled, virtual jamming is repeatedly applied as shown in 812.

For the remaining subset of stations, in step 813 ACK collision according to present invention is applied. In a specific embodiment, colliding ACK is generated whenever packet transmission to the AP from any of the remaining subset stations is detected. Alternatively or in addition to, the colliding ACK is generated whenever packet transmission from the AP to any of the remaining subset of stations is detected. Inflicting such ACK collision is useful to disrupt the station in the BSS that is hidden from the sniffer (for example due to obstacles to radio propagation from the sniffer to the station) and hence could not be disabled by virtual jamming packets transmitted from the sniffer.

In step 814, the sniffer monitors if any successful communication is happening between the AP and wireless stations on which ACK collision is applied. For example, the sniffer may verify that the packets to or from said stations are being continually retransmitted or the transmission has halted altogether. If so, ACK collision for said remaining subset of stations is continued as shown in step 815.

On the other hand, if combination of virtual jamming and ACK collision as described above does not perform as desired, for example due to large number of hidden stations or due to large number of stations that do not honor the NAV field in the packet, in step 816 ACK collision is applied to all packet transmission to the AP. Alternatively or in addition to, the ACK collision is also applied to all packet transmissions by the AP.

In step 817 the effect of ACK collision is monitored. If successful, ACK collision is continued for all stations in the BSS as shown in step 818.

On the other hand, if general ACK collision does not perform as desired, finally in step 819 a brute force technique of radio jamming or link hogging is applied.

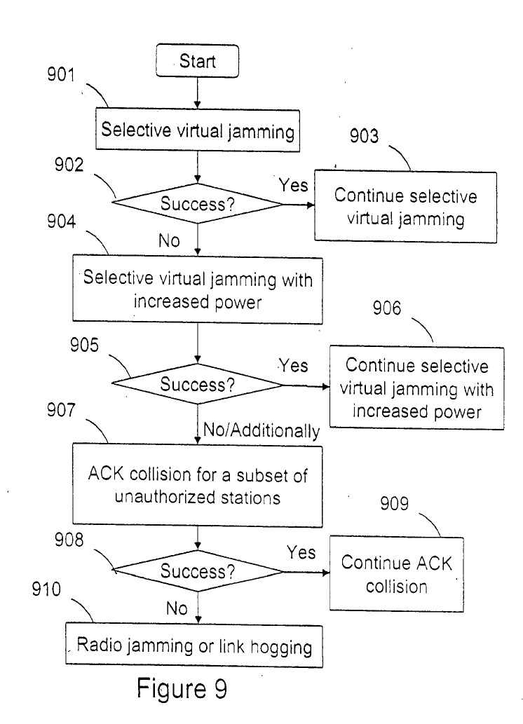

An example embodiment of the adaptive method according to present invention to selectively block unauthorized wireless stations in an ad hoc network in described below with reference to FIG. 9. This diagram is merely an example, which should not unduly limit the scope of the claims herein. One of ordinary skill in the art would recognize other variations, modifications, and alternatives. The adaptive method is applied to selectively block unauthorized stations with minimal disruption to authorized stations.

In step 901, selective virtual jamming according to the present invention is applied.

In step 902, the effect of selective virtual jamming is monitored by the sniffer. If at least a large subset of unauthorized stations is observed to be blocked which can be determined, for example, by monitoring if any packet transmissions happen from unauthorized stations, the selective virtual jamming is continued as shown in step 903.

On the other hand, if the selective virtual jamming is deemed not to produce expected result, in step 904 it is applied again but with increased transmit power from the sniffer.

Again the effect of this on unauthorized stations is monitored by the sniffer in step 905. If at least a large subset of unauthorized stations is observed to be blocked, the selective virtual jamming with increased power is continued as shown in step 906.

On the other hand, if the selective virtual jamming with increased power is deemed not to produce expected result, for example due to the factors such as some of the unauthorized stations being hidden from the sniffer or not honoring the NAV field in the packets, in step 907 ACK collision is applied on the unauthorized stations that do not respond to the selective virtual jamming.

Step 908 continues to monitor the transmissions in the ad hoc network to determine if selective virtual jamming in combination with ACK collision on the subset of unauthorized stations is effective and if deemed effective, ACK collision on the subset of stations is continued in step 909.

If not, brute force radio jamming or link hogging is applied to disrupt the ad hoc network in step 910.

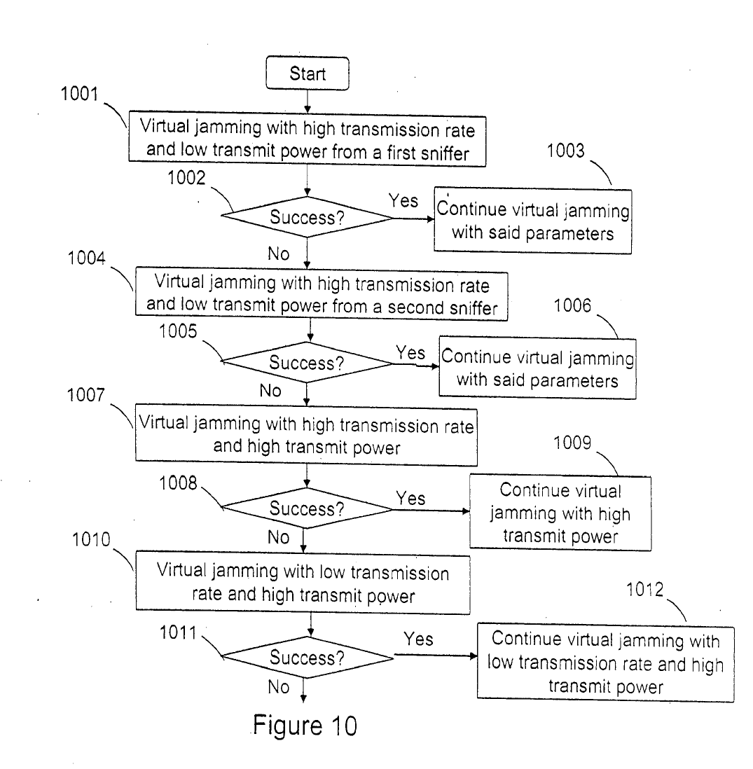

Yet an alternative embodiment of the adaptive method according to present invention to selectively block unauthorized wireless stations in a BSS or an ad hoc network is described below with reference to FIG. 10. This diagram is merely an example, which should not unduly limit the scope of the claims herein. One of ordinary skill in the art would recognize other variations, modifications, and alternatives. The adaptive method is applied to selectively block the unauthorized stations with minimal possible disruption to authorized stations.

In step 1001, virtual jamming according to the present invention is applied, with the packets with high value for NAV field transmitted at a high transmission speed (e.g., 11 Mbps) and a low transmit power (e.g., 0 dbm) from a first sniffer. This will restrict the number of authorized users that will undesirably be affected by the OTA prevention to those within a short range from the sniffer. In addition, the air-time consumed by the OTA prevention packets is maintained low due to the high transmission speed.

In step 1002, the effect of virtual jamming is monitored by the first sniffer. If at least a large subset of unauthorized stations is observed to be blocked, the virtual jamming is continued as shown in step 1003.

On the other hand, if the application of virtual jamming as above is deemed not to produce expected result, in step 1004 it is applied again from a different sniffer. That is, the packets with high value for NAV field transmitted at a high transmission speed (e.g., 11 Mbps) and a low transmit power (e.g., 0 dbm), but from a different sniffer (second sniffer).

In step 1005, the effect of virtual jamming is monitored by either the first or the second sniffer or other sniffer or any combination of these. If at least a large subset of unauthorized stations is observed to be blocked, the virtual jamming is continued as shown in step 1006.

On the other hand, if the application of virtual jamming as above is deemed not to produce expected result, in step 1007 it is applied again but with different parameter values, for example, the packets with high value in NAV filed are now transmitted at a high transmission speed (e.g., 11 Mbps) and an increased transmit power (e.g., 20 dbm).

In step 1008, the effect of virtual jamming is monitored by the sniffer. If favorable, the virtual jamming is continued as shown in step 1009.

Else in step 1010, virtual jamming is applied with yet different parameter values, for example, the packets with high value in NAV filed are now transmitted at a low transmission speed (e.g., 1 Mbps) and a high transmit power (e.g., 20 dbm), and the like.

In step 1011, the effect of virtual jamming is monitored by the sniffer. If favorable, the virtual jamming is continued as shown in step 1012. Else, brute force techniques like radio jamming or link hogging are applied.

In one specific embodiment, if none of the OTA prevention techniques produce desirable result, the unauthorized AP or the AP with which an unauthorized wireless station is communicating is disconnected from the wired side. For this, a query is launched to determine the Ethernet switch port where said AP is connected. For example, SNMP (simple network management protocol) query can be used for this purpose. The query can include the MAC address of the AP or the wireless station. The switch replies to the SNMP management entity providing the identity of the switch port where said AP or wireless station is connected. The SNMP command is then launched by the management entity to deactivate said switch port.

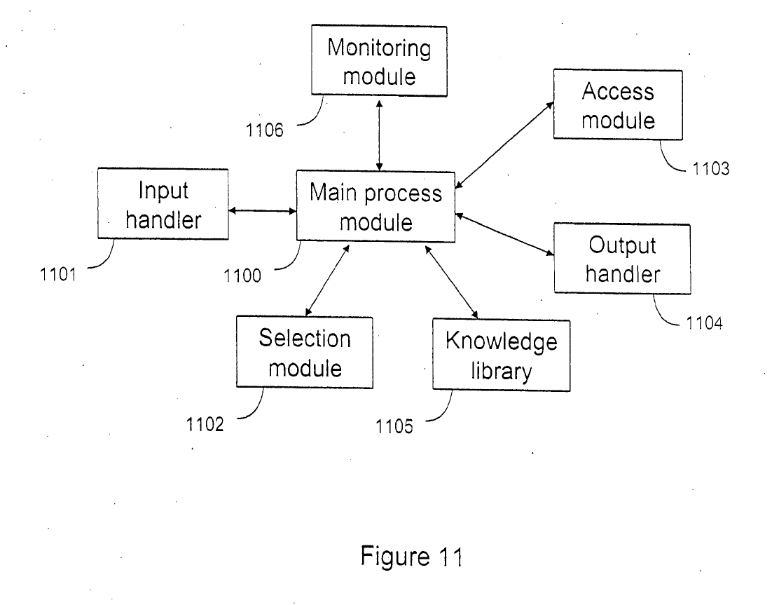

According to one embodiment of the present invention illustrated in FIG. 11, an intrusion prevention system is provided. The system includes a main process module 1100, an input handler 1101 coupled to the main process module, a selection module 1102 coupled to the main process module, an access module 1103 coupled to the main process module and an output handler 1104 coupled to the main process module. Each of the modules comprises one or more computer executable codes, one or more electronic hardware modules or combination thereof. The communication between modules is provided via techniques such as, but not limited to, inter process signals, function calls, data bus, communication over one or more computer networks, etc.

The input handler is adapted to receive an indication comprising at least identity information. The indication is associated with a selected wireless device. The selected wireless device is preferably associated with an undesirable wireless communication within the selected local geographic region. In a specific embodiment, the identity information comprises a MAC address of the device. The indication is preferably received from the intrusion detection system.

The selection module is adapted to select one or more processes directed to restrict the selected wireless device from engaging in wireless communication. In a specific embodiment, the one or more processes are selected from at least a forced deauthentication/disassociation process, a virtual jamming process, a selective virtual jamming process, an access point flooding process, an acknowledgement collision process, a beacon disruption process, a link hogging process, and a power save mode disruption process. In a specific preferred embodiment, the selection module uses the identity information associated with the selected wireless device as a key to derive information associated with the one or more processes from a knowledge library 1005 that is coupled to the main process module. In an alternative specific embodiment, the selection module uses information associated with the effect of previously applied one or more wireless communication restricting processes on the selected wireless device to select the one or more processes. Said information is preferably collected by the monitoring module 1106.

The access module is adapted to perform a prioritized access to a wireless medium using at least one of one or more sniffer devices. The output handler is adapted to transmit one or more packets from the at least one of one or more sniffer devices. The one or more packets are directed to perform at least one of the one or more processes to restrict the selected wireless device.

It is also understood that the examples and embodiments described herein are for illustrative purposes only and that various modifications or changes in light thereof will be suggested to persons skilled in the art and are to be included within the spirit and purview of this application and scope of the appended claims.

1-48. (canceled)

49. A method for monitoring a local area wireless communication network including a process for disrupting undesirable wireless communications between wireless devices, the method comprising:
detecting undesirable wireless communication between at least two wireless devices using first one or more sniffer devices, at least a first wireless device of the at least two wireless devices is unauthorized and is provided in a portable computing device, the undesirable wireless communication using at least one first value associated with at least one parameter included in at least a first beacon packet for synchronization process, the first beacon packet being transmitted by a second wireless device of the at least two wireless devices; and
transmitting at least a first fake beacon packet from a second sniffer device, the first fake beacon packet comprising at least one second value associated with the at least one parameter, the second value being set to make at least the first wireless device interpret that the at least one parameter has changed its value;
whereupon the first fake beacon packet is characterized by the second value associated with the at least one parameter to desyncronize the synchronization process associated with the undesirable wireless communication between the at least two wireless devices;
whereupon the at least one parameter is provided in a BSSID (Basic Service Set Identifier) field of the first beacon packet and the first fake beacon packet.

50. The method of claim 49 wherein the undesirable wireless communication is an ad hoc mode wireless communication in accordance with an IEEE 802.11 protocol.

51. The method of claim 49 wherein the undesirable wireless communication is an infrastructure mode wireless communication in accordance with an IEEE 802.11 protocol.

52. The method of claim 49 wherein the first value is not equal to the second value.

53. The method of claim 49 wherein the fake beacon packet comprises a fake probe response packet.

54. The method of claim 49, and further comprising synchronizing the first wireless device from the at least two wireless devices with the second sniffer device using the second value associated with the at least one parameter.

55. The method of claim 54, and further comprising transmitting at least a second fake beacon packet from the second sniffer device, the second fake beacon packet comprising a third value associated with the at least one parameter.

56. The method of claim 55, and further comprising synchronizing the second wireless device from the at least two wireless devices with the second sniffer device using the third value associated with the at least one parameter.

57. The method of claim 56, and further comprising providing a man-in-the-middle attack between the at least two wireless devices, the man-in-the-middle attack being provided by the second sniffer device.

58. The method of claim 49 wherein the second sniffer device is one of the first one or more sniffer devices.

59. A system for disrupting undesirable wireless communications between wireless devices, the system comprising:
a processor unit;
a radio interface unit; and
a memory unit having stored therein instructions for the processor unit to:
detect undesirable wireless communication between at least two wireless devices, the undesirable wireless communication using at least one first value associated with at least one parameter included in at least a first beacon packet for synchronization process, the first beacon packet being transmitted by one of the at least two wireless devices; and
transmit at least a first fake beacon packet using the radio interface unit, the first fake beacon packet comprising at least one second value associated with the at least one parameter, the second value being set to make a first wireless device of the at least two wireless devices interpret that the at least one parameter has changed its value;
whereupon the first fake beacon packet is characterized by the second value associated with the at least one parameter to desyncronize the synchronization process associated with the undesirable wireless communication between the at least two wireless devices;
whereupon the at least one parameter is provided in a BSSID (Basic Service Set Identifier) field of the first beacon packet and the first fake beacon packet.

60. The system of claim 59 wherein the undesirable wireless communication is an ad hoc mode wireless communication in accordance with an IEEE 802.11 protocol.

61. The system of claim 59 wherein the undesirable wireless communication is an infrastructure mode wireless communication in accordance with an IEEE 802.11 protocol.

62. The system of claim 59 wherein the first value is not equal to the second value.

63. The system of claim 59 wherein the fake beacon packet comprises a fake probe response packet.

64. The system of claim 59 wherein the memory unit having stored therein further instructions for the processor unit to synchronize the first wireless device of the at least two wireless devices with the radio interface unit using the second value associated with the at least one parameter.

65. The system of claim 64 wherein the memory unit having stored therein further instructions for the processor unit to transmit at least a second fake beacon packet using the radio interface unit, the second fake beacon packet comprising a third value associated with the at least one parameter.

66. The system of claim 65 wherein the memory unit having stored therein further instructions for the processor unit to synchronize a second wireless device from the at least two wireless devices with the radio interface unit using the third value associated with the at least one parameter.

67. The system of claim 66 wherein the memory unit having stored therein further instructions for the processor unit to provide a man-in-the-middle attack between the at least two wireless devices, the man-in-the-middle attack being provided using the radio interface unit.

68. A method for monitoring a local area wireless communication network including a process for disrupting undesirable wireless communications between wireless devices, the method comprising:
detecting undesirable wireless communication between at least two wireless devices, the undesirable wireless communication using at least one first value associated with at least one parameter included in at least a first beacon packet for synchronization process, the first beacon packet being transmitted by one of the at least two wireless devices; and
transmitting at least a first fake beacon packet from a radio interface separate from any radio interface on the at least two wireless devices, the first fake beacon packet comprising at least one second value associated with the at least one parameter, the second value being set to make one of the at least two wireless devices interpret that the at least one parameter has changed its value;
whereupon the first fake beacon packet is characterized by the second value associated with the at least one parameter to desyncronize the synchronization process associated with the undesirable wireless communication between the at least two wireless devices;
whereupon the at least one parameter is provided in a BSSID (Basic Service Set Identifier) field of the first beacon packet and the first fake beacon packet.
